(19) United States
(12) Patent Application Publication
(10) Pub. No.: US 2006/0127757 A1
(43) Pub. Date: Jun. 15, 2006

(54) Alkaline cell and production method for same

(76) Inventors: Takeshi Shishido, Miyagi (JP); Iwazou Takahashi, Miyagi (JP); Shunji Watanabe, Miyagi (JP); Tsugio Sakai, Miyagi (JP)

Correspondence Address: ADAMS & WILKS, 17 BATTERY PLACE, SUITE 1231, NEW YORK, NY, 10004, US

(21) Appl. No.: 11/288,735

(22) Filed: Nov. 29, 2005

(30) Foreign Application Priority Data
Dec. 15, 2004 (JP) 2004-363126

(51) Int. Cl. H01M 2/02; H01M 4/42; H01M 2/08; H01M 4/50; H01M 4/54; H01M 10/26

(52) U.S. Cl. 429/176; 429/229; 429/185; 429/219; 429/224; 429/206; 29/623.5

(57) ABSTRACT

The invention provides a mercury-free alkaline cell which does not generate a hydrogen gas. The alkaline cell according to the invention is composed of: a positive electrode; a negative electrode containing zinc alloy powder; a separator which separates the positive electrode from the negative electrode; an alkaline electrolyte; a positive electrode can imparted with the positive electrode, a negative electrode can imparted with the negative electrode, the negative electrode can having a tin-coated layer subjected to a thermal treatment at a melting point (232° C.) of tin or higher and coming in contact with the negative electrode via the tin-coated layer; and a gasket interposed between the positive electrode can and the negative electrode can.

### BACKGROUND OF THE INVENTION

1. Field of the Invention

The present invention relates to a coin-type alkaline cell or a button-type alkaline cell.

2. Related Art

An alkaline cell used for a small-sized electronic appliance such as a wrist watch is, as shown in FIG. 3, constructed such that an open end of a positive electrode can 2 is sealed with a negative electrode can 4 via a gasket 6. In the negative electrode can 4, a folded portion 4a in which an open edge end thereof is folded back along an outer peripheral face in a U-shape as cross-section and a folded bottom portion 4b are formed. At the folded portion 4a, the negative electrode can 4 is tightened with an inner peripheral face of the open end edge of the positive electrode can 2 via the gasket 6, to thereby achieve hermetical sealing.

The negative electrode can 4 is press-formed in a cup shape from a triple-layered cladding material having a nickel layer 7 made of nickel, a stainless steel layer 8 made of stainless steel and a current collector layer 9 made of copper.

The positive electrode can 2 holds a positive electrode 1, while the negative electrode can 4 holds a negative electrode 3 which contains mercury-free zinc or zinc alloy powder as a negative electrode active material. The negative electrode 3 is separated from the positive electrode 1 by a separator 5 and is filled with an alkaline electrolyte.

The negative electrode 3 is allowed to use amalgamated zinc or zinc alloy powder in place of zinc or zinc alloy powder, to thereby suppress generation of a hydrogen gas (H₂) from zinc powder or zinc alloy powder or suppress the generation of the hydrogen gas (H₂) from the current collector layer 9 in which the hydrogen gas is ordinarily generated by allowing zinc or zinc alloy powder to come into contact with copper thereof of the negative electrode can through the alkaline electrolyte. The generation of the hydrogen gas results from a reaction which dissolves zinc or zinc alloy powder in the alkaline electrolyte, while oxidizing zinc into zinc oxide. The generation of the hydrogen gas is suppressed, as described above, by using the amalgamated zinc. The consequence is the avoidance of capacity deterioration due to hydrogen generation and deterioration of leakage resistance property and swelling of the cell due to an increased internal pressure.

### SUMMARY OF THE INVENTION

An alkaline cell according to the present invention contains a positive electrode; a negative electrode containing zinc alloy powder; a separator which separates the positive electrode from the negative electrode; an alkaline electrolyte; a positive electrode can imparted with the positive electrode; a negative electrode can imparted with the negative electrode, the negative electrode can having a tin-coated layer subjected to a thermal treatment at a melting point (232° C.) or higher and coming in contact with the negative electrode via the tin-coated layer; and a gasket interposed between the positive electrode can and the negative electrode can.

Further, a method for producing an alkaline cell according to the invention involves:

a first step of forming a tin-coated layer on a negative electrode can;

a second step of subjecting the tin-coated layer to a thermal treatment at a melting point (232° C.) of tin or higher; and

a third step of folding back a positive electrode can and a negative electrode can which contain a positive electrode, a negative electrode, a separator and an alkaline electrolyte such that a gasket is interposed therebetween and, then, tightening such folded portion for a hermetic sealing.

In order to effectively suppress the generation of the hydrogen gas, a method for applying a coating layer containing tin which is a metal having a higher hydrogen over potential than copper is desirable.

By using the invention, hydrogen gas (H₂) which will be generated by allowing zinc which is a negative electrode active material to come into contact with the current collector (copper) layer of the negative electrode can is suppressed, corrosion of zinc is suppressed and, then, a leakage resistance property against a creeping-up phenomenon of the alkaline electrolyte can be enhanced.

The tin-coated layer before subjected to the thermal treatment has defects such as pinholes or cracks causing the current collector layer (copper layer) to be exposed. Since copper has a lower-hydrogen over potential than tin, when copper comes in contact with zinc powder which is a negative active material, a hydrogen gas is generated.

However, when the tin-coated layer is subjected to the thermal treatment at the melting point of tin or higher, the defects such as pinholes or cracks are repaired and, then, the copper layer is not exposed, to thereby prevent generation of the hydrogen gas.

Further, according to the invention, since an outer peripheral portion 6b of a projected portion 6a of the gasket at the center side is allowed to come in contact with an inner face of the negative electrode can 4, a leakage resistance property is enhanced and, even when a certain extent of variation of accuracy is present at the time the tin-coated film is provided on an inner face of the negative electrode can, transfer of the alkaline electrolyte is prevented by the fact that the outer peripheral portion 6b of the projected portion of the gasket at the center side is in contact with the inner face of the negative electrode can and, further, since a space between the outer peripheral portion 6b of the projected portion 6a of the gasket 6 at the center side and an inner face of the negative electrode can 4 is 0.05 mm or less, the transfer of zinc powder in the negative electrode is prevented and, further, different from a case in which a tip end of the gasket comes in contact with the inner face of the negative electrode can, since the projected portion of the gasket at the center side does not serve as a support of the negative electrode can at the time of sealing the cell and, then, contact between the negative electrode and the positive electrode in the cell is not interfered and corrosion reaction of zinc which is a negative electrode active material of the current collector (copper) layer of the negative electrode can is not progressed, to thereby improve the deterioration of a capacity retention property.

According to the invention, the alkaline cell which is excellent in a discharge property can be realized without using mercury.

### BRIEF DESCRIPTION OF THE DRAWINGS

FIG. 1 is a cross-sectional diagram of an alkaline cell according to the present invention;

FIG. 2 is a cross-sectional diagram of a negative electrode can according to the invention; and

FIG. 3 is a cross-sectional diagram of a conventional alkaline cell.

### DETAILED DESCRIPTION OF THE INVENTION

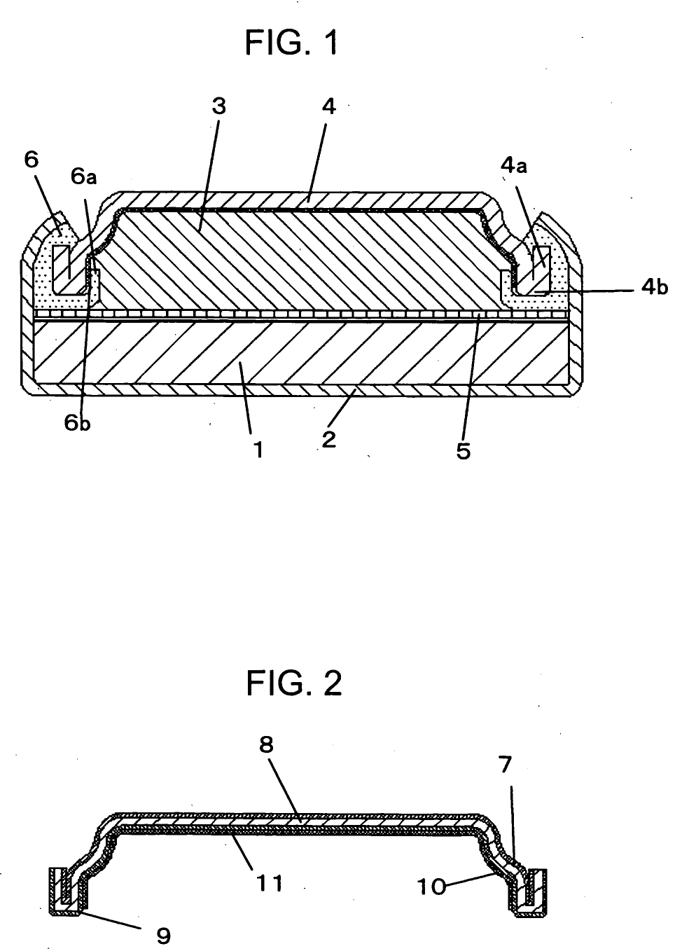

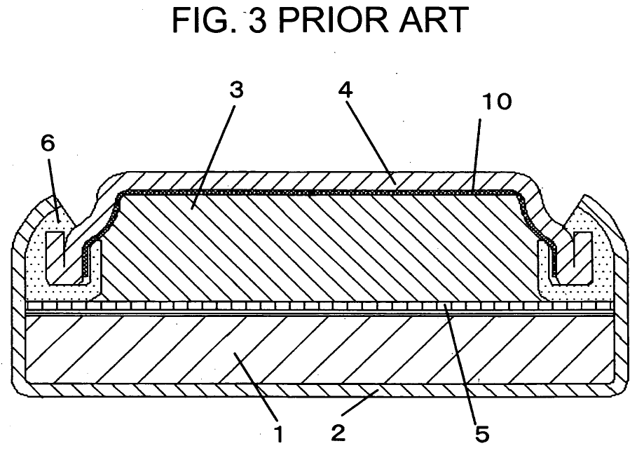

The alkaline cell of the present invention is now described in detail with reference to preferred embodiments shown in FIGS. 1 and 2.

FIG. 1 shows a cross-sectional view of an alkaline cell of button type. An open end edge of a positive electrode can 2 is sealed with a negative electrode can 4 via a gasket 6 having a U-shape as cross-section.

The positive electrode can 2 is made of-a stainless steel sheet with nickel plating. It functions also as a positive electrode terminal. The positive electrode can 2 holds the positive electrode 1 formed in a coin-like or button-like pellet. Then, a separator 5 is arranged on the positive electrode 1 held in the positive electrode can 2. The separator 5 may be a triple-layer laminate composed of a non-woven fabric, cellophane and a sheet of graft-polymerized polyethylene. The separator 5 is impregnated with an alkaline electrolyte. The alkaline electrolyte can be an aqueous solution of sodium hydroxide or potassium hydroxide, or a mixed aqueous solution of sodium hydroxide and potassium hydroxide.

The ring gasket 6 is arranged on an inner peripheral face of the open end edge of the positive electrode can 2. Then, the negative electrode 3 is placed on the separator 5. The negative electrode 3 is a gel-like substance composed of a mercury-free zinc or zinc alloy powder, an alkaline electrolyte and a thickener.

The negative electrode can 4 is inserted into the open end edge of the positive electrode can 2 such that the negative electrode 3 is contained. In the negative electrode can 4, a folded portion 4a in which an open edge end thereof is folded back along an outer peripheral face in a U-shape as cross-section and a folded bottom portion 4b are formed. At the folded portion 4a, the negative electrode can 4 is tightened with an inner peripheral face of the open end edge of the positive electrode can 2 via the gasket 6, to thereby achieve hermetical sealing.

The negative electrode can 4 is obtained by firstly press-forming a triple-layered cladding material composed of a nickel layer 7, a stainless steel layer 8, and a current collector layer 9 made of copper in a cup shape, with the current collector layer 9 being arranged to be inside and, then, forming a tin-coated layer 10 on the thus-press-formed cladding material by electroless plating of tin or the likes (FIG. 2). After the tin-coated layer is formed, it is subjected to a thermal treatment at the melting point (232° C.) of tin or higher. When the tin-coated layer is subjected to the thermal treatment at the melting point of tin or higher, since pinholes or cracks which are present in the tin-coated layer are filled, the copper layer is not exposed, to thereby prevent generation of the hydrogen gas.

Further, when the tin-coated layer is provided only in an inner face region 11 of the negative electrode can, the leakage resistance property is enhanced, which is preferred. The term “inner face region” as used herein is defined as an inside (side to be in contact with electrolyte) of the negative electrode can 4 as well as a region of a face more inner than the folded bottom portion 4b. The tin-coated layer is not formed in the folded portion 4a which is in contact with the gasket and the folded bottom portion 4b and prevents the electrolyte from creeping up by a creeping phenomenon, to thereby enhance the leakage resistance property. This was because the alkaline electrolyte more likely crept up on the tin-coated layer 10 rather than the current collector layer 9.

By covering unnecessary portions (the folded portion 4a which has been folded back along the outer peripheral face in a U-shape as cross-section and the folded bottom portion 4b) with a masking tape or the like, the tin-coated layer can be formed only in the inner face region by using the electoless plating of tin or the like and, then, the thus-formed tin-coated layer can be subjected to the thermal treatment.

In another case, the triple-layered cladding material is press-formed in a cup shape with the current collector layer 9 being arranged to be inside, the tin-coated layer is formed by using the electroless plating and, then, by removing or peeling the unnecessary portions by means of etching using an acid or the like, the tin-coated layer can be formed only in the inner face region of the cup and, thereafter, the thus-formed tin-coated layer can be subjected to the thermal treatment.

It is preferable that thickness of the tin-coated layer 10 is allowed to be from 0.05 μm to 5 μm. In a case in which the thickness thereof is less than 0.05 μm, since it takes a long time to perform the thermal treatment and the negative electrode can is distorted, the case is not preferred. Further, since it takes a long time to form the coated layer, the case is not appropriate.

As for a thermal treatment atmosphere of the tin-coated layer 10, an oxygen concentration is preferably from 0.01% to 1%. It is considered that, by allowing the oxygen concentration to be low as the atmosphere, for a thermal treatment atmosphere of the tin-coated layer 10 of the negative electrode can, a surface oxidation of the tin-coated layer can be suppressed. In an atmosphere having an oxygen concentration of over 1%, at the time of subjecting the tin-coated layer 10 to a thermal treatment, there is a risk of causing a problem in a discharge property due to an increase of contact resistance to be derived from oxidation of a tin surface. Further, when the oxygen concentration is lower than 0.01%, not only a noticeable influence is hardly given to a surface resistance of the tin-coated layer 10, but also a longer time and extra expenditure are required to maintain the atmosphere thereof and, accordingly, no particular merit is generated at such a low level of the oxygen concentration as described above.

As for the alkaline electrolyte, it is preferable that sodium hydroxide is in the range of from 15 to 30% by weight or potassium hydroxide is in the range of from 1 to 15% by weight. When a ratio of potassium hydroxide in the alkaline electrolyte is less than 1% by weight, enhancement of the discharge property to be caused by the excellent conductivity of the aqueous solution of potassium hydroxide compared with the aqueous solution of sodium hydroxide is small, which is not preferred. Further, when a ratio of potassium hydroxide is more than 15% by weight, since the aqueous solution of potassium hydroxide has a higher wetting property to copper than the aqueous solution of sodium hydroxide, the leakage resistance property is deteriorated, which is not preferred. Sodium hydroxide and potassium hydroxide can be used as an electrolyte either alone or in mixture.

Further, by allowing the outer peripheral portion 6b of the projected portion 6a of the gasket 6 at the center side to come to be in contact with the inner face of the negative electrode can 4 or by allowing a space between the outer periphery 6b of the projected portion 6a of the gasket 6 at the center side and the inner face of the negative electrode can 4 to be 0.05 mm or less, the outer peripheral portion 6b of the projected portion 6a of the gasket at the center side does not become a support against the negative electrode can 3 and, then, the contact between the negative electrode and the positive electrode in the cell is not interfered with each other, which is preferred.

As for the positive electrode active materials to be used in the invention, silver oxide, manganese dioxide, a composite oxide, nickel oxyhydroxide can be used; however the invention is not limited thereto.

### EXAMPLE 1

A cell having a constitution as shown in FIG. 1 was prepared as Example 1. A negative electrode can 4 having a folded portion 4a and a folded bottom portion 4b was formed by press-forming a triple-layered cladding material in a thickness of 0.2 mm composed of a nickel layer 7, a stainless steel layer 8 made of SUS304 and a current collector layer 9 made of copper. This negative electrode can 4 was subjected to etching by a mixed aqueous solution of sulfuric acid and hydrogen peroxide, washed with water, dipped in an electroless plating solution with shaking, washed with warm water, washed with water and, then, dried, to thereby form a tin-coated layer in a thickness of 0.3 μm over an entire region of a copper face of the negative electrode can 4. Thereafter, after an inner face region 11 of the negative electrode can was masked with a chlorosulfonated polyethylene rubber stopper, unnecessary portions of the tin-coated layers in the folded portion 4a and the folded bottom portion 4b in the inner face was peeled off and removed by being dipped in a peeling-off solution for tin plate whose main component is oxide on a copper substrate and, then, the resultant negative electrode can was subjected to a thermal treatment at 232° C. in an atmosphere of oxygen concentration of 1% or less, to thereby prepare the negative electrode can 4.

On the other hand, an alkaline electrolyte containing 22% by weight of sodium hydroxide and 9% by weight of potassium hydroxide was poured into the positive electrode can 2 and, then, a disk-like pellet of the positive electrode 1 was inserted thereinto, to thereby allow the positive electrode 1 to absorb the alkaline electrolyte.

Next, the separator 5 which had been pressed off in a circular shape from a triple-layered structure composed of a non-woven fabric, cellophane and a film of graft-polymerized polyethylene was placed on the pellet of the positive electrode 1. Then, the separator 5 was impregnated with an alkaline electrolyte containing 22% by weight of sodium hydroxide and 9% by weight of potassium hydroxide which was added dropwise.

Next, a gel-like negative electrode 3 composed of a mercury-free zinc alloy powder containing aluminum, indium and bismuth, zinc oxide, a thickener, sodium hydroxide, potassium hydroxide and water was placed on the separator 5. The negative electrode can 4 was inserted into the open end edge of the positive electrode can 2 such that it covered the negative electrode 3, with the ring gasket 6 made of nylon-66 and coated with asphalt plus epoxy-type sealant interposed between them. The open end edge of the positive electrode can 2 was hermetically sealed by means of caulking. In this way-the desired alkaline cell was obtained. In this occasion, the outer peripheral portion 6b of the projected portion 6a of the gasket 6 at the center side was allowed to come into contact with the inner face of the negative electrode can 4.

### EXAMPLE 2

In the Example 2, the temperature of the thermal treatment of the tin-coated layer was set to be 250° C. Other conditions were same as in Example 1 to prepare the alkaline cell.

### EXAMPLE 3

In the Example 3, a space between the outer peripheral portion 6b of the projected portion 6a of the gasket 6 at the center side and the inner face of the negative electrode can was allowed to be 0.05 mm. The temperature of the thermal treatment of the tin-coated layer was set to be 240° C. Other conditions were same as in Example 1 to prepare the alkaline cell.

### EXAMPLE 4

In the Example 4, a space between the outer peripheral portion 6b of the projected portion 6a of the gasket 6 at the center side and the inner face of the negative electrode can was allowed to be 0.07 mm. The temperature of the thermal treatment of the tin-coated layer was set to be 240° C. Other conditions were same as in Example 1 to prepare the alkaline cell.

### EXAMPLE 5

In the Example 5, the alkaline electrolyte was allowed to be a mixed solution containing 15% by weight of sodium hydroxide and 15% by weight of potassium hydroxide. The temperature of the thermal treatment of the tin-coated layer was set to be 240° C. Other conditions were same as in Example 1 to prepare the alkaline cell.

### EXAMPLE 6

In the Example 6, the alkaline electrolyte was allowed to be a mixed solution containing 30% by weight of sodium hydroxide and 1% by weight of potassium hydroxide. The temperature of the thermal treatment of the tin-coated layer was set to be 240° C. Other conditions were same as in Example 1 to prepare the alkaline cell.

### EXAMPLE 7

In the Example 7, the alkaline electrolyte was allowed to be a mixed solution containing 30% by weight of sodium hydroxide and 15% by weight of potassium hydroxide. The temperature of the thermal treatment of the tin-coated layer was set to be 240° C. Other conditions were same as in Example 1 to prepare the alkaline cell.

### EXAMPLE 8

In the Example 8, the alkaline electrolyte was allowed to be a mixed solution containing 30% by weight of sodium hydroxide and. 0.5% by weight of potassium hydroxide. The temperature of the thermal treatment of the tin-coated layer was set to be 240° C. Other conditions were same as in Example 1 to prepare the alkaline cell.

### EXAMPLE 9

In the Example 9, the alkaline electrolyte was allowed to be a mixed solution containing 15% by weight of sodium hydroxide and 20% by weight of potassium hydroxide. The temperature of the thermal treatment of the tin-coated layer was set to be 240° C. Other conditions were same as in Example 1 to prepare the alkaline cell.

### COMPARATIVE EXAMPLE 1

In Comparative Example 1, an alkaline cell was prepared by using the negative electrode can in which the tin-coated layer having a thickness of 0.1 μm was formed by ordinary electroless plating on the negative electrode can 4. A thermal treatment was not performed on the tin-coated layer. Other conditions were same as in Example 1.

### COMPARATIVE EXAMPLE 2

In Comparative Example 2, the thermal treatment was performed on the tin-coated layer at 210° C. Other conditions were same as in Example 1 to prepare the alkaline cell.

210 cells each of Examples 1 to 9 and Comparative Examples 1 and 2 were prepared. 100 cells out of cells thus prepared in each of Examples 1 to 9 and Comparative Examples 1 and 2 were stored under a severe environment of 40° C. 90% RH and evaluation results on ratio of occurrence of leakage after 120 days of storage and 140 days of storage are shown in Table 1. Further, 100 cells out of cells thus prepared in each of Examples 1 to 9 and Comparative Examples 1 and 2 were stored for 100 days under an environment of 60° C. 0% RH and evaluation results on discharge capacity [mAh] at a terminal voltage of 1.2 V after 30 kΩ constant discharge are shown in Table 1. Incidentally, in each cell, initial discharge capacity was about 28 mAh. Lastly, 10 cells out of cells thus- prepared in-each of Examples 1 to 9 and Comparative Examples 1 and 2 were evaluated on closed circuit voltage [V] after 5 seconds under conditions of initial (depth of discharge: 0%), load resistance: 2 kΩ in an environment of −10° C. The results are shown in Table 1.

TABLE 1

| | | | Composition of | | Ratio of occurrence | | Capacity | Closed circuit |
|---|---|---|---|---|---|---|---|---|
| | Space between | | electrolyte | | of leakage | | retention | voltage; |
| | gasket and | Thermal treatment | KOH | NaOH | After | After | property after | Depth of |
| | negative electrode | temperature (° C.) | wt % | wt % | 120 days | 140 days | 100 days | discharge 0% |
| Example 1 | In contact | 232 | 9% | 22% | 0% | 0% | 20.1 mAh | 1.39 V |
| Example 2 | In contact | 250 | 9% | 22% | 0% | 0% | 20.5 mAh | 1.39 V |
| Example 3 | 0.05 mm | 240 | 9% | 22% | 0% | 0% | 20.5 mAh | 1.39 V |
| Example 4 | 0.07 mm | 240 | 9% | 22% | 0% | 4% | 19.6 mAh | 1.38 V |
| Example 5 | In contact | 240 | 15% | 15% | 0% | 0% | 20.0 mAh | 1.37 V |
| Example 6 | In contact | 240 | 1% | 30% | 0% | 0% | 20.3 mAh | 1.39 V |
| Example 7 | In contact | 240 | 15% | 30% | 0% | 0% | 20.3 mAh | 1.38 V |
| Example 8 | In contact | 240 | 0.5% | 30% | 0% | 0% | 20.1 mAh | 1.31 V |
| Example 9 | In contact | 240 | 20% | 15% | 0% | 3% | 20.2 mAh | 1.39 V |
| Comparative | In contact | None | 9% | 22% | 3% | 10% | 18.7 mAh | 1.38 V |
| Example 1 | | | | | | | | |
| Comparative | In contact | 210 | 9% | 22% | 2% | 8% | 18.8 mAh | 1.39 V |
| Example 2 | | | | | | | | |

Firstly, when Examples 1 and 2 and Comparative Examples 1 and 2 were compared with one another on the basis of Table 1, it is found that, by forming the tin-coated layer by using the electroless plating and, then, heating it at the melting point (232° C.) or higher, the leakage resistance property and the capacity retention property can be enhanced. In Examples 1 and 2, there was no leakage at all both after 120 days and 140 days.

To contrast, in Comparative Example 1, 3% showed leakage after120 days while 10% showed leakage after 140 days;whereas, in Comparative Example 2, 2% showed leakage after 120 days while 8% showed leakage after 140 days.

In Examples 1 and 2,-it is considered that, since the tin-coated layer was subjected to the thermal treatment at a temperature of the melting point or higher and, accordingly, defects such as pinholes or cracks were completely repaired and the copper layer was entirely covered, generation of the hydrogen gas was able to be prevented and, then, a high leakage resistance was obtained. To contrast, in Comparative Example 1, since the tin-coated layer was not subjected to the thermal treatment and, accordingly, retains defects such as pinholes or cracks and the current collector (copper) layer was exposed. For this account, it is considered that zinc powder or the like and the copper layer came in contact with each other, the hydrogen gas was generated, an inner pressure was increased and, then, leakage was generated. Further, it is considered that, although Comparative Example 2 was subjected to a thermal treatment, the treatment temperature was relatively low and, accordingly, defects such as pinholes or cracks were not repaired and, as a result, the current collector layer was exposed.

Next, when Examples 1, 3 and 4 were compared thereamong on the basis of Table 1, there was no leakage at all in both of Examples land 3. When Example4 was compared with Comparative Example 1, although the ratio of occurrence of leakage of Example 4 was low, about 3% thereof showed leakage after 140 days of storage. In the alkaline cell in which the space between the outer peripheral portion 6b of the projected portion 6a of the gasket 6 at the center side and the inner face of the negative electrode can is 0.05 mm or less, the leakage resistance property and the capacity retention property were excellent. This was because that, by allowing the outer peripheral portion 6b of the projected portion 6a of the gasket 6 at the center side and the inner face of the negative electrode can 4 to come into contact with each other or allowing a space therebetween to be smaller than 0.05 mm or less, zinc powder in the negative electrode at the time of sealing the cell was able to be prevented from entering the space between the gasket and the negative electrode can. When zinc powder entered between the gasket and the negative electrode can, zinc powder came into contact with the current collector layer containing copper which has a low hydrogen over potential, to thereby cause generation of hydrogen gas. Further, a certain extent of error to be generated at the time of assembling the negative electrode can and the gasket or a certain extent of error of a position at which the tin-coated layer is formed can be tolerated so long as the space between the outer peripheral portion 6b of the projected portion 6a of the gasket 6 at the center side and the inner face of the negative electrode can is 0.05 mm or less. Particularly, even when the current collector layer was exposed to some extent due to a variance of an end portion of the tin-coated layer, the zinc powder does not enter the space between the gasket and the negative electrode can and, then, hydrogen is prevented from being generated.

When Examples 5 to 7 were compared thereamong on the basis of Table 1, it is found that, by allowing the alkaline electrolyte to be an aqueous solution in which sodium hydroxide is in an amount of from 15% by weight to 30% by weight and potassium hydroxide is in an amount of from 1 to 15% by weight, a favorable closed circuit voltage property has been obtained. Further, there was no leakage at all in Examples 5 to 7. In order to obtain a favorable closed circuit voltage property, an amount of sodium hydroxide to be added is appropriately in the range of from 15 to 30% by weight.

On the other hand, although Example 8 has no generation of leakage and is more favorable than Example 1, the closed circuit voltage is lower than other Examples. This was because, it is considered, that an amount of potassium hydroxide contained in the alkaline electrolyte was small. The aqueous solution of potassium hydroxide is excellent in conductivity compared with the aqueous solution of sodium hydroxide. For this account, in Example 8 in which the amount of potassium hydroxide to be contained is small, it is considered that the closed circuit voltage has been lowered. For this account, in a case in which the closed circuit voltage characteristic was taken into a serious consideration, it is preferable that potassium hydroxide is contained in an amount of 1% by weight or more in the alkaline electrolyte.

In Example 9, leakage was generated after 140 days of storage. This was because an amount of potassium hydroxide contained in the alkaline electrolyte was large. Since the aqueous solution of potassium hydroxide has a higher wetting property to copper than the aqueous solution of sodium hydroxide, when the amount of potassium hydroxide is large, a creep phenomenon is generated, to thereby cause leakage. In order to improve the leakage resistance property, it is particularly preferable that the amount of potassium hydroxide to be contained is allowed to be 15% by weight or less.

Further, as for coating layer for the negative electrode can, not only tin but also at least one metal or alloy of indium (melting point: 156.6° C.) and bismuth (melting point: 271.4° C.) and alloys thereof is permissible as a metal or an alloy which has a higher hydrogen over potential than copper.

According to the invention, since the tin-coated layer 10 free from defects such as pinholes, cracks and contaminations with impurities can be formed inside the negative electrode can 4, the generation of the hydrogen gas (H₂) which is otherwise generated by allowing zinc which is a negative electrode active material to be in contact with the current collector layer 9 of the negative electrode can 4 is suppressed, corrosion of zinc is suppressed and, also, leakage resistance property by the creeping-up phenomenon of the alkaline electrolyte can be obtained. According to the invention, a favorable alkaline cell can be obtained without using mercury.

As for methods for forming the tin-films, not only wet-type methods such as the electroless plating method and the electrolytic plating method, but also dry-type methods such as a PVD (physical vapor deposition) method and a CVD (chemical vapor deposition) method are permissible.

Further, the invention is not limited to such examples and comparative examples as described above. It goes without saying that various changes, modifications and alterations may be made in the invention without departing from the scope and spirit thereof.

What is claimed is:

1. An alkaline cell, comprising: a positive electrode; a negative electrode comprising zinc alloy powder; a separator which separates the positive electrode from the negative electrode; an alkaline electrolyte; a positive electrode can imparted with the positive electrode; a negative electrode can imparted with the negative electrode, the negative electrode can having a tin-coated layer subjected to a thermal treatment at a melting point (232° C.) or higher and coming in contact with the negative electrode via the tin-coated layer; and a gasket interposed between the positive electrode can and the negative electrode can.

2. The alkaline cell according to claim 1, wherein the positive electrode comprises silver oxide or manganese dioxide.

3. The alkaline cell according to claim 1, wherein the tin-coated layer is a tin-coated layer subjected to a thermal treatment in an atmosphere of an oxygen concentration of 1% or less.

4. The alkaline cell according to claim 1, wherein the tin-coated layer is formed in the region of an inner face of the negative electrode can.

5. The alkaline cell according to claim 1, wherein sodium hydroxide is present in an amount of from 15 to 30% by weight or potassium hydroxide is present in an amount of from 1 to 15% by weight in the alkaline electrolyte.

6. The alkaline cell according to claim 1, wherein a peripheral portion of a projected portion of the gasket at the center side comes in contact with an inner face of the negative electrode can or has a space of 0.05 mm or less apart from the inner face of the negative electrode can.

7. The alkaline cell according to claim 1, wherein the tin-coated layer is a tin-coated layer formed by any one technique selected from the group consisting of: electroless plating; electrolytic plating, vapor deposition; sputtering and ion plating.

8. A method for producing an alkaline cell, comprising:
a first step of forming a tin-coated layer on a negative electrode can;
a second step of subjecting the tin-coated layer to a thermal treatment at a melting point (232° C.) of tin or higher; and
a third step of caulking a positive electrode can and a negative electrode can which contain a positive electrode, a negative electrode, a separator and an alkaline electrolyte such that a gasket is interposed therebetween to effect a hermetic sealing.
